(19) United States
(12) Patent Application Publication
(10) Pub. No.: US 2024/0171019 A1
(43) Pub. Date: May 23, 2024

(54) ELECTRIC MOTOR FOR AN ACTUATOR

(71) Applicant: HELLA GmbH & Co. KGaA, Lippstadt (DE)

(72) Inventors: Daniel NOELKEL, Lippstadt (DE); Katrin ZIMMERMANN, Soest (DE)

(73) Assignee: HELLA GmbH & Co. KGaA, Lippstadt (DE)

(21) Appl. No.: 18/427,377

(22) Filed: Jan. 30, 2024

Related U.S. Application Data
(63) Continuation of application No. PCT/EP2022/069929, filed on Jul. 15, 2022.

(30) Foreign Application Priority Data
Jul. 30, 2021 (DE) 10 2021 119 817.8

(51) Int. Cl. H02K 1/18; H02K 1/2706; H02K 7/116

(52) U.S. Cl. CPC H02K 1/18; H02K 1/2706; H02K 7/116

(57) ABSTRACT

An electric motor for an actuator, which includes a stator including a multiplicity of electromagnets, each of which is formed from an iron core and a wire coil, a rotor, rotatably supported in the stator, including a multipole ring magnet or a multiplicity of permanent magnets, a drive-side end of the rotor being designed as a pinion, a gearing driven by the pinion, and a printed circuit board including electrical and/or electronic components, the printed circuit board being electrically connectable to the stator. The electric motor is to be improved in such a way that as little installation space as possible is taken up while having sufficient power, and a high degree of design freedom is made possible for an assigned gearing. This is achieved in that at least one bearing of a toothed wheel of the gearing is arranged on the stator.

This nonprovisional application is a continuation of International Application No. PCT/EP2022/069929, which was filed on Jul. 15, 2022, and which claims priority to German Patent Application No. 10 2021 119 817.8, which was filed in Germany on Jul. 30, 2021, and which are both herein incorporated by reference.

### BACKGROUND OF THE INVENTION

### Field of the Invention

The invention relates to an electric motor for an actuator, which comprises a stator including a multiplicity of electric magnets, a rotor, rotatably supported in the stator, including a multipole ring magnet or a multiplicity of permanent magnets, a drive-side end of the rotor being designed as a pinion, a gearing drivable by the pinion, and a printed circuit board including electrical and/or electronic components, the printed circuit board being electrically connectable to the stator.

### Description of the Background Art

Electric motors are known per se and are frequently used, for example, in motor vehicles for different purposes, e.g., as actuator motors.

An electric motor for an actuator (actuator drive) is described in DE 101 151 155 A1, in which a gearing is designed as a worm gear. The electric motor (drive motor) is a DC motor and therefore has a relatively long axial extension. The electric motor and the gearing are supported in a shared housing. On the whole, the actuator drive takes up a relatively large amount of installation space.

WO 2017/029124 A1, which corresponds to US 2018/0241282, discloses an actuator (positioner), including an electric motor and a gearing. A toothed wheel of the gearing assigned to a driving pinion of the electric motor is supported radially on the outside at a distance from the electric motor. In this case as well, the actuator requires a relatively large amount of installation space.

### SUMMARY OF THE INVENTION

It is therefore an object of the invention to provide an electric motor for an actuator, which takes up as little installation space as possible while having sufficient power, and which simultaneously permits a high degree of design freedom for an assigned gearing.

In an example, at least one bearing of a toothed wheel of the gearing is arranged on the stator. This allows the gearing to be arranged spatially very close to the electric motor; in particular, a distance between parallel-running rotation axes of the rotor and the toothed wheel may be kept short. The actuator as a whole is highly compact and lighter in weight than in the case of the known actuator constructions; due to the associated reduction in size of an arrangement (retention) of all bearings of the toothed wheels of the gearing. A support structure necessary in the known actuators for the shaft of the toothed wheel is omitted.

A bearing of the toothed wheel within the meaning of this invention may mean either a rotatably fixed shaft, which is fastened on the stator and on which the toothed wheel is rotatably supported, or a bearing bush for a shaft which is fixedly connected to the toothed wheel.

The bearing of one of the toothed wheels can be assigned to the pinion arranged on the stator. This alone effectuates an essential part of the reduction in size and thus the compact design of the actuator.

The stator can be at least partially overmolded with plastic, and at least one bearing bush for an assigned one of the toothed wheels can be formed with the aid of the overmolding. The stator is optimally protected hereby, and the separate formation of the bearing bush is omitted.

A shaft of the toothed wheel can be fastened to a ring of the stator. The overmolding with plastic may be omitted.

Two or more of the bearings can be arranged on the stator. The electric motor may be used hereby without changes for different gearing constellations.

The electric motor can be arranged together with the gearing in a shared housing. This offer optimal protection of the complete actuator and makes it easier to mount, for example, in a motor vehicle.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a top view of an example of an actuator with the gearing cover opened;

FIG. 2 shows a perspective view of an overmolded stator from FIG. 1;

FIG. 3 shows a perpendicular section of the electric motor of the actuator from FIG. 1; and

FIG. 4 shows an example of a stator.

### DETAILED DESCRIPTION

An actuator is made up of an electric motor, a gearing, and an assigned control and/or regulating circuit.

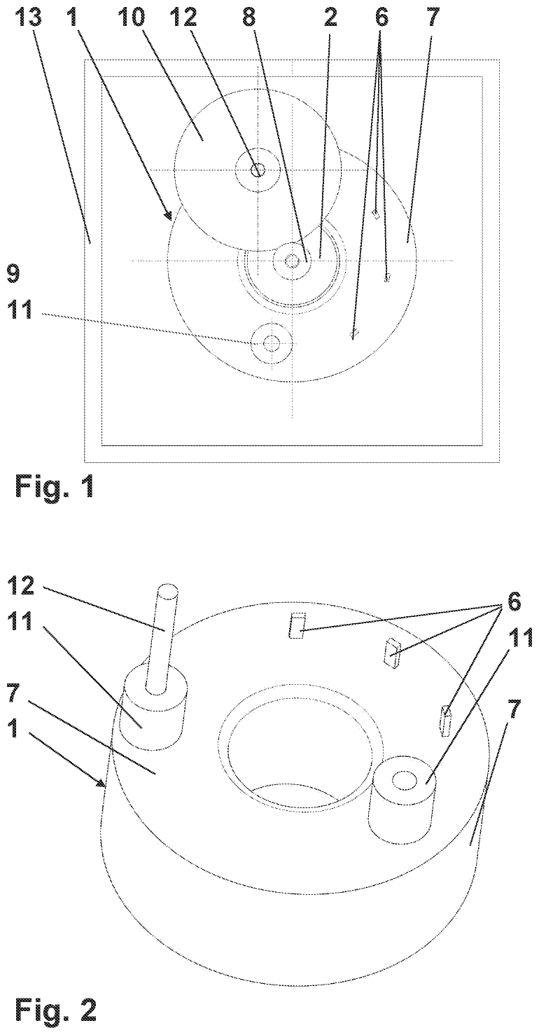

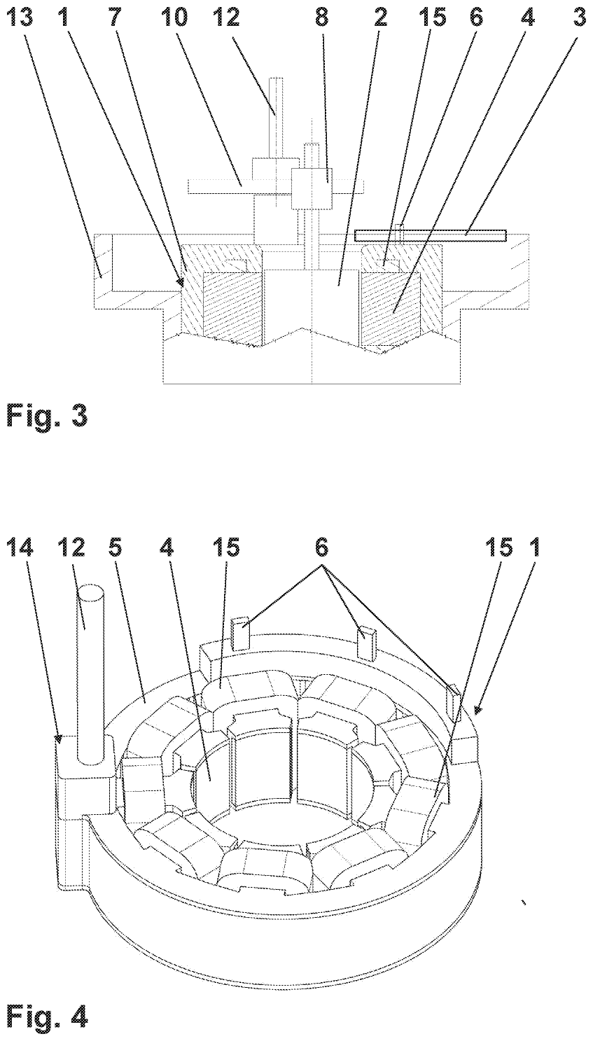

As is apparent from FIGS. 1 through 3, the brushless electric motor comprises a stator 1, a rotor 2, and a printed circuit board 3 in a first example. The electric motor is a DC motor.

Stator 1 comprises a multiplicity of N×3 iron cores 4 (N is an integer), which point radially to the inside from an inside of a circular ring 5 (cf. FIG. 4). The nine iron cores in this case are formed in an identical manner, and each one is surrounded by its own separate wire coil 15 for generating a magnetic field. The coils are supplied by a three-phase current during operation, which is controlled and/or regulated via a suitable control circuit. Three wires of wire coils 15 are connected to a contact, for example an insulation displacement contact. Each of the insulation displacement contacts is provided, for example, with a press-fit contact 6 on its upper end facing away from stator 1.

Other types of contacting, such as resistance welding or soldering, may be used as an alternative to the insulation displacement contacts.

Other components for contacting with printed circuit board 3, such as terminals or solder tags, may be used as an alternative to press-fit contacts 6.

Rotor 2 is rotatably supported in stator 1 and includes a multipole permanent magnet. For example, a first axis fastened in the housing or a shaft is used for supporting rotor 2. It has a pinion 8 on its drive side,

Within the scope of this invention, pinion 8 is assigned exclusively to rotor 2; all other wheels of an assigned gearing 9 are referred to as toothed wheels 10.

Printed circuit board 3 comprises an electrical circuit for driving wire coils 15 and thus the electromagnets of stator 1. At least one sensor, to which an electronic evaluation unit is assigned, may furthermore be fastened on a lower side of printed circuit board 3 facing stator 1. The Hall sensor is arranged in such a way that it may be influenced by the permanent magnet.

With the exception of press-fit contacts 6, stator 1 is completely surrounded by a jacket 7 made from plastic, as is particularly apparent from FIG. 2. Two bearings 11 in the form of sleeves or bushes are arranged here on an upper side of the stator assigned to pinion 8. It is clearly apparent from FIG. 2 that the two bearings 11 have a different radial distance from a rotation axis of rotor 2.

Gearing 9 comprises a multiplicity of toothed wheels 10, the quantity and number of teeth thereof depending on the desired step-up or step-down. Only a first one of toothed wheels 10 is illustrated, which is assigned to pinion 8 and engages therewith. First toothed wheel is rotatably supported on a second axis 12, which is fastened in one of bearings 11 on the left here according to the figures.

The electric motor, printed circuit board 3, and gearing 9 are arranged in a housing 13, which is formed in two parts from a base part and a cover. A plug socket is provided for the electrical connection of the actuator to a vehicle electronic system of a motor vehicle. Other ones of toothed wheels 10 are supported in housing 13 and/or on stator 1.

An example of a second stator is illustrated in FIG. 4. This example differs from the first one as follows:

Stator 1 is only partially overmolded by the plastic, an insulation of the coils already being arranged such that it belongs to stator 1 prior to the overmolding. An upper side of stator 1 facing pinion 8 is largely free of the plastic; the plastic may be arranged only in the region of press-fit contacts 6 and second shaft 12 for the purpose of stabilization and/or insulation.

Second axis 12 is fastened in a bore, which is introduced into a radially outer region of ring 5. The fastening of second axis 12 takes place, in particular, by pressing into ring 5. Ring 5 may have an outwardly pointing protrusion 14 in the region of this bore to maintain a predetermined spacing of the axes and/or achieve a stable wall thickness. For the axial orientation of associated toothed wheel 10, a base is formed with the aid of the overmolding, on which a part of toothed wheel 10 rests and is thus axially fixed in place.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electric motor for an actuator, the electric motor comprising:
a stator including at least two electromagnets, each of the at least two electromagnets being formed from an iron core and a wire coil;
a rotor rotatably supported in the stator, the rotor comprising a multipole ring magnet or a plurality of permanent magnets, a drive-side end of the rotor formed as a pinion;
a gearing drivable by the pinion;
a printed circuit board including electrical and/or electronic components, the printed circuit board being electrically connectable to the stator; and
at least one bearing of a toothed wheel of the gearing being arranged on the stator.

2. The electric motor according to claim 1, wherein the bearing of one of the toothed wheels assigned to the pinion is arranged on the stator.

3. The electric motor according to claim 1, wherein the stator is at least partially overmolded with a jacket made from plastic, and wherein the at least one bearing for an assigned one of the toothed wheels is formed via the overmolding.

4. The electric motor according to claim 1, wherein a second shaft of the toothed wheel is fastened in a ring of the stator.

5. The electric motor according to claim 1, wherein two or more of the bearings are arranged on the stator.

6. The electric motor according to claim 1, wherein the stator, the rotor, and the gearing are arranged in a shared housing.
